(19) United States
(12) Patent Application Publication
(10) Pub. No.: US 2004/0052640 A1
(43) Pub. Date: Mar. 18, 2004

(54) All weather windmills

(76) Inventor: Ghazi Khan, Fremont, CA (US)

Correspondence Address: GHAZI A. KHAN, 3328 BAYLIS ST, FREMONT, CA, 94538, US

(21) Appl. No.: 10/241,844

(22) Filed: Sep. 12, 2002

(51) Int. Cl. F03D 1/06

(52) U.S. Cl. 416/10; 415/4.5

(57) ABSTRACT

A new modification in conventional wind mills wherein the wings are tilted between 95 degree to 159 degrees and their wings are modified, having thicker supporting shafts at the base and gradual thinner shafts towards their tips at their outermost circumference These wings are made with flexible material in metal or plastics to flex the wings with the wind gusts and reduce their sweep area and angle of attack in sync with wind speed.

### PRIOR ART

The angle of attack is set at maximum to achieve maximum sweep area. This has a disadvantage that in case of high winds, the blades need a gear system as well as an effective break system to save the overloading of current. Expensive governors or the controllers are required to keep steady currents however the structural integrity of the structure and the machinery are still vulnerable to hurricanes and tornados. The current technology is derived from nature where tall trees bend their branches in sync with the strong wind current and avoid damage and secondly in nature all trees have thicker base and gradual thinner branches till its leaves to create flexibility to sync with the wind current instead of rigid flat resistance.

### DESCRIPTION

FIG. 1.

(a) The side view of the preferred embodiment where with wings tilt is kept at 120 degrees angle and can be set according to the preferred application within the range prescribed.

(b) The distance of the central vertical pole is at wing's length to avoid collusion in case of high wing pressure where the sweep area is automatically reduced in proportion to the increased winds

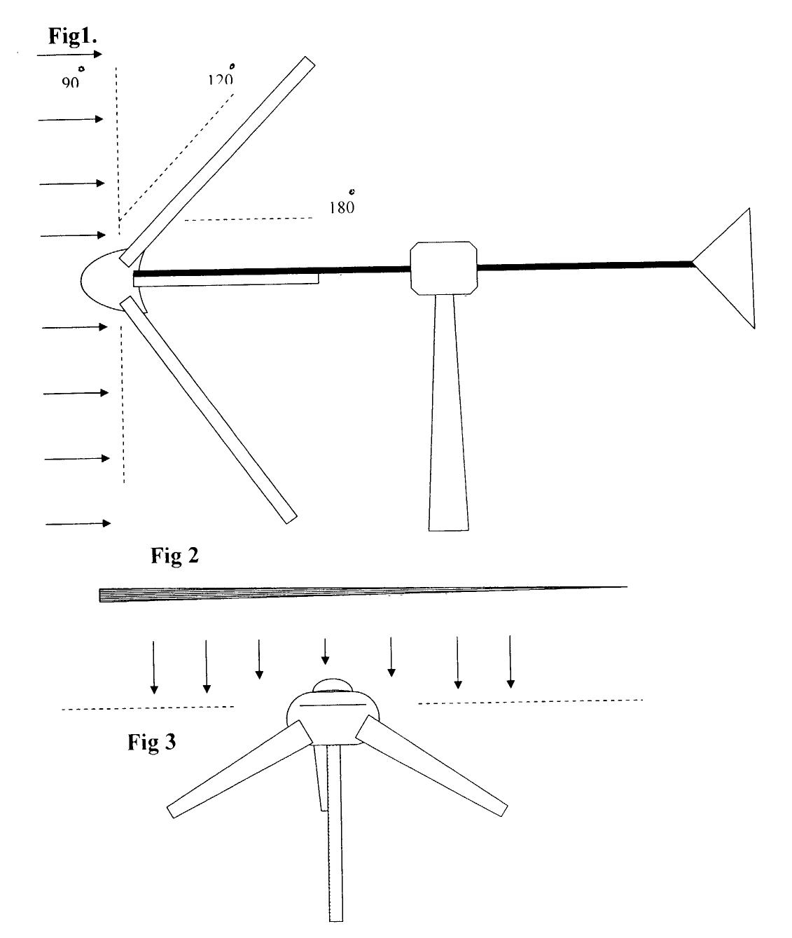

FIG. 2. The diagrammatic view of the wing shaft is disclosed in this preferred embodiment where the thickness of the blade shaft is gradually reduced towards its tip to give the blade enough flexibility to bend and reduce its circumference and reduce the sweeping area in proportion to the increase in the wind speed. The shape of the wing shaft may be round, triangulate, rectangular, pentagon, hexagon or any other shape, the main emphasis is on the gradual reduction in size of the shaft towards its ending tip starting from its base

FIG. 3. The top view plan wherein the angle of the blades are shown tilted backward to allow air flow to flex the blades and reduce their angle of attack

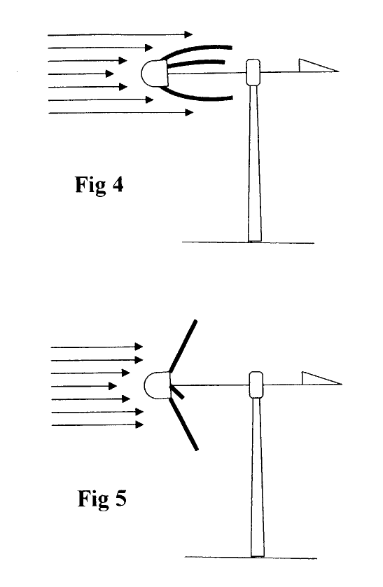

FIG. 4. is the diagrammatic side view of the preferred embodiment in wind storm showing the bending of wings and reducing the angle of attack as well as the sweep area.

FIG. 5. is the diagrammatic side view of the preferred embodiment in normal wing conditions.

1. A modified design for a windmill, with multiple wings arranged with an angle of attack at more than 95 degrees and less than 159 degrees.

2. The wing shaft is thicker at its base and gradually thinner at its tip giving the wing flexibility to bend along with the wind in the direction of the wind in case of high winds.

3. The pole is away at wings length to avoid collision in case of high bending of wings due to wind storms.
